(19) United States
(12) Patent Application Publication
(10) Pub. No.: US 2019/0104745 A1
(43) Pub. Date: Apr. 11, 2019

(54) Teff Pie

(71) Applicant: Aklog Asfaw, Bloomington, MN (US)

(72) Inventor: Aklog Asfaw, Bloomington, MN (US)

(21) Appl. No.: 16/152,697

(22) Filed: Oct. 5, 2018

Related U.S. Application Data
(60) Provisional application No. 62/568,908, filed on Oct. 6, 2017.

(51) Int. Cl. A21D 13/04; A21D 10/00; A21D 2/36; A21D 6/00

(52) U.S. Cl. CPC A21D 13/04; A21D 6/003; A21D 2/36; A21D 10/002

(57) ABSTRACT

A method for making a Teff Pie including the steps of forming a piecrust dough; forming a pre-injera mixture; fermenting the pre-injera mixture to form injera dough; separating the injera dough from reserve water; refrigerating the injera dough; re-mixing the injera dough with a starter and the reserve water to form an injera mixture; cooking the injera mixture to form injera; forming a lower layer and an upper layer of piecrust dough, placing the lower layer of piecrust dough in a baking pan; placing a lower layer of injera on top of the lower layer of piecrust dough; placing a sauce on top of the injera; placing an tipper layer of injera on top of the sauce; placing an upper layer of piecrust dough on top of the upper layer of injera and baking the Teff Pie.

### CROSS-REFERENCE TO RELATED APPLICATIONS

This application claims the benefit of U.S. Provisional Patent Application Ser. No. 62/568,908 filed Oct. 6, 2017, which is incorporated by reference herein in its entirety.

### FIELD OF THE INVENTION

The present invention in general relates to the ingredients and to the method of making a unique and delicious layered Teff Pie.

### BACKGROUND OF THE INVENTION

In the past Teff flour has been used to provide a unique flavor as a single-crust pastry dough. Teff dough has been used in the baking of dessert pies, quiche and/or pot pies. Teff flour when baked may provide a flaky and/or nutty pie crust for seasonal dessert pies. In the past Teff flour has not been use to form a unique Teff Pie as disclosed and as claimed by applicant herein.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. § 1.56(a) exists.

All U.S. patents and applications and all other published documents mentioned anywhere in this application are incorporated herein by reference in their entirety.

Without limiting the scope of the invention, a brief description of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. § 1.72.

### GENERAL DESCRIPTION OF THE INVENTION

In some embodiments the Teff Pie and the method of making Teff Pie, includes the formation of a piecrust dough. The pie crust dough is formed by mixing 1 cup of Teff flower, 1.5 cups all-purpose flower, 1 teaspoon salt, 1 stick unsalted butter (chilled), ¼ teaspoon fenugreek powder, one teaspoon black seed, and 10 tablespoons of ice water, where the fenugreek powder, black seed, salt, the Teff flower and the all-purpose flour are mixed in a medium-size bowl. The butter is then added/cut into the piecrust mixture until the piecrust mixture has a course appearance, whereupon the water is gradually added, and the piecrust mixture is continued to be mixed until the piecrust dough forms to a desired consistency.

In some embodiments the Teff Pie and the method of making Teff Pie, includes the pre-formation of a Teff Injera. A Teff Injera is formed by mixing in a large container with 6 cups of Teff flour and 6 cups of water. Following mixing of the Teff flour and 6 cups of water, another 6 cups of water is gradually added while mixing continues, forming the pre-injera mixture.

The pre-injera mixture is then covered and the pre-injera mixture is permitted to ferment for a period of time of approximately thirty-six hours, whereupon the water separates from the pre-injera mixture to form the injera dough.

Following the expiration of approximately thirty-six hours, the injera dough is removed from the water and is placed into a refrigerator for a period of time of approximately four hours.

The remaining water from the pre-injera mixture is retained, and is identified as the reserve water. The reserve water is placed into a separate container. The reserve water includes dissolved flour which did not congeal into injera dough.

In some embodiments the Teff Pie and the method of making Teff Pie, approximately twenty-four hours after the formation of the pre-injera mixture includes the removal of ½ cup of the reserve water which includes the mixed Teff flour and water mixture prior to the removal of the injera dough. The ½ cup of the reserve water (mixed Teff flour and water mixture) is then mixed with 1 cup of water to form the “Starter”.

After approximately forty hours, the starter is gradually added and mixed back into the reserve water. The mixed starter and reserve water is then thoroughly mixed with the previously removed injera dough to form an injera mixture. The injera mixture in some embodiments has the consistency of pancake batter. A griddle may then be heated to approximately 400 degrees. Approximately 1 cup of the injera mixture may then be poured onto the heated griddle in a circular motion. The griddle may then be covered and the injera mixture may be cooked on the griddle for approximately thirty seconds. The cover may then be removed and the cooked Teff Injera may be removed from the griddle allowing the Teff injera to cool.

In some embodiments the Teff Pie and the method of making Teff Pie initiates with the preheating, an oven to 400 degrees. On a lightly floured surface one-half of the pie crust dough is rolled out into ⅛ inch thick circle, having at least a 10-inch diameter dimension. One half of the rolled out pie crust dough is then transferred into a 10 inch deep baking pan.

In some embodiments the Teff Pie and the method of making Teff Pie includes the laying out ½ of one of the cooked Teff Injera into the baking pan above the pie crust dough and then placing 6 to 8 tablespoons of at least one of the Key Sir, Shiro Wat, Gomen Wat, Tikel Gomen, Yemesir Wat, Fossolia, and Doro Wat sauces/fillings, or combinations thereof, onto the top of the ½ Teff Injera in the baking pan. The other ½ of the cooked Teff Injera is then placed on top of the sauces/fillings in the baking pan. The upper layer of Teff Injera is then covered with the remaining ½ of the piecrust dough, which has been formed into a ⅛ inch thick circle, having at least a 10-inch diameter dimension.

The baking pan now has a lower layer of piecrust dough and a lower layer of Teff Injera above the lower layer of piecrust dough. Sauces or filling is placed above the lower layer of Teff Injera. An upper layer of Teff Injera is placed above the sauces and fillings and an upper layer of piecrust dough is then placed above upper layer of Teff Injera.

In some embodiments the baking pan is then covered and the baking pan containing the lower layer of pie crust dough, the lower ½ layer of cooked Teff Injera, the sauces, and live upper ½ layer of cooked Teff Injera with the remaining ½ of the pie crust dough is then placed into a preheated oven for 25 minutes at 400 degrees Fahrenheit. After 25 minutes the oven temperature may be reduced to 350 degrees Fahrenheit for baking for an additional 15 minutes. The Teff Pie may then be removed from the oven and allowed to cool to a desired temperature.

In at least one alternative embodiment, the method identified above for making the piecrust dough and the Teff Injera is repeated. In addition, an oven is preheated to 400 degrees. On a lightly floured surface one-half of the pie crust dough is rolled out into a ⅛ inch thick circle, having at least a 10-inch diameter dimension. The rolled out pie crust dough is then cut into small flat squares. The cooked Teff Injera is also cut into small flat squares having the same dimension as the cut piecrust dough. A square of cut Teff Injera is then placed on top of a cut square of piecrust dough. Then a desired amount of at least one of the Key Sir, Shiro Wat, Gomen Wat, Tikel Gomen, Yemesir Wat, Fossolia, and Doro Wat sauces, or combinations thereof, is placed onto the lower layer of Teff Injera Another square of cooked and cut Teff Injera is then placed on top of the sauces. Another cut piece of piecrust dough is then placed on top of the upper cut piece of cooked Teff Injera, whereupon the edges of the squares are pinched and sealed. The layered squares of piecrust dough, Teff Injera, sauce, Teff Injera and piecrust dough are then baked for 20 minutes at 400 degrees, removed from heat and allowed to cool to a desired temperature.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE DRAWINGS

FIG. 1. is a flow chart depicting of one alternative embodiment of the method of formation of the piecrust dough of the invention.

FIG. 2A. is a flow chart depicting of one alternative embodiment of a step in the method of formation of the Teff Injera of the invention.

FIG. 2B. is a flow chart depicting of one alternative embodiment of a step in the method of formation of the Teff Injera of the invention.

FIG. 2C. is a flow chart depicting of one alternative embodiment of a step in the method of formation of the Teff Injera of the invention.

FIG. 3. is a flow chart depicting of one alternative embodiment of the method of formation of the Teff Pie of the invention.

FIG. 4. is a flow chart depicting of one alternative embodiment of the method of formation of the Teff Pie of the invention.

FIG. 5. is a flow chart depicting of one alternative embodiment of the method of formation of the Key Sir sauce of the invention.

FIG. 6. is a flow chart depicting of one alternative embodiment of the method of formation of the Shiro Wat Sir sauce of the invention.

FIG. 7. is a flow chart depicting of one alternative embodiment of the method of formation of the Gomen Wat Sir sauce of the invention.

FIG. 8. is a flow chart depicting of one alternative embodiment of the method of formation of the Tikel Gomen sauce of the invention.

FIG. 9. is a flow chart depicting of one alternative embodiment of the method of formation of the Yemesir Wat sauce of the invention.

FIG. 10. is a flow chart depicting of one alternative embodiment of the method of formation of the Fossolia sauce of the invention.

FIG. 11. is a flow chart depicting of one alternative embodiment of the method of formation of the Dora Wat Sir sauce of the invention.

FIG. 12. is a cross-sectional side view taken along the line 14-14 of FIG. 13 of one alternative embodiment of the Teff Pie of the invention.

FIG. 13. is an isometric view of one alternative embodiment of the Teff Pie of the invention.

FIG. 14. is a cross-sectional side view taken along the line 14-14 of FIG. 13 of one alternative embodiment of the Teff Pie of the invention.

### DETAILED DESCRIPTION OF THE PREFERRED EMBODIMENTS

In al least on embodiment the method of making of a Teff Pie 10 begins by the acquisition of ingredients to form the piecrust dough 12 and on or more of the sauces or 136. The identified sauces or fillings 136 which may be used individually or in an combination in the Teff Pie 10 disclosed herein. The sauces and/or fillings 136 include the Key Sir Sauce 30, Shiro Wat sauce 62, Gomen Wat sauce 68, Tikel Gomen sauce 78, Yemesir Wat sauce 84, Fossolia sauce 90 and Doro Wat sauce 100 individually or in any combination.

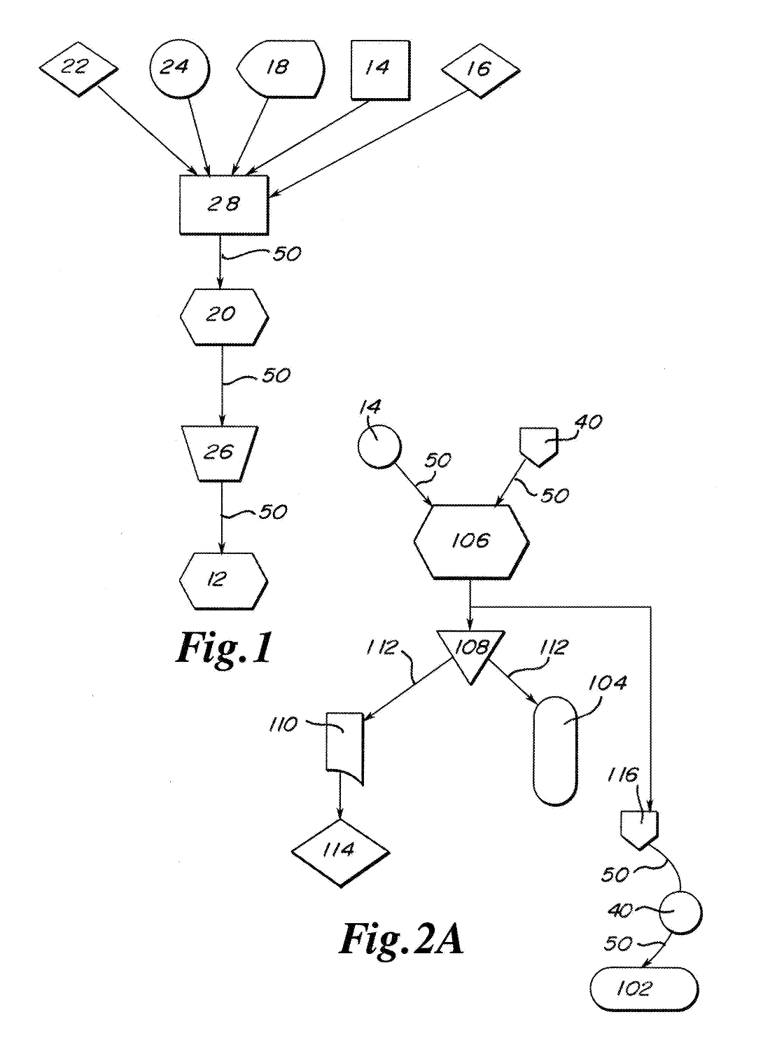

Referring to FIG. 1., in one embodiment the pie crust dough is formed of 1 cup teff flower 14, 1.5 cups all-purpose flower 16, 1 teaspoon salt 18, 1 stick unsalted butter (chilled) 20, ¼ teaspoon fenugreek powder 22, 1 teaspoon black seed 24, and 10 tablespoons ice water 26.

In one embodiment, the method of formation of the Teff Pie 10 includes the step of mixing 50 in a medium-size bowl 28 the fenugreek powder 22, the black seed 24 and salt 18 with the teff flower 14 and the all-purpose flour 16. The butter 20 is then added to the bowl 28 by cutting of the butter 20 during mixing 50 until the ingredients in the bowl 28 have a course appearance. The ice water 26 is then gradually added and mixed 50 until the piecrust dough 12 obtains a desired consistency. The piecrust dough 12 is then ready to roll out for use during the formation of the Teff Pie 10.

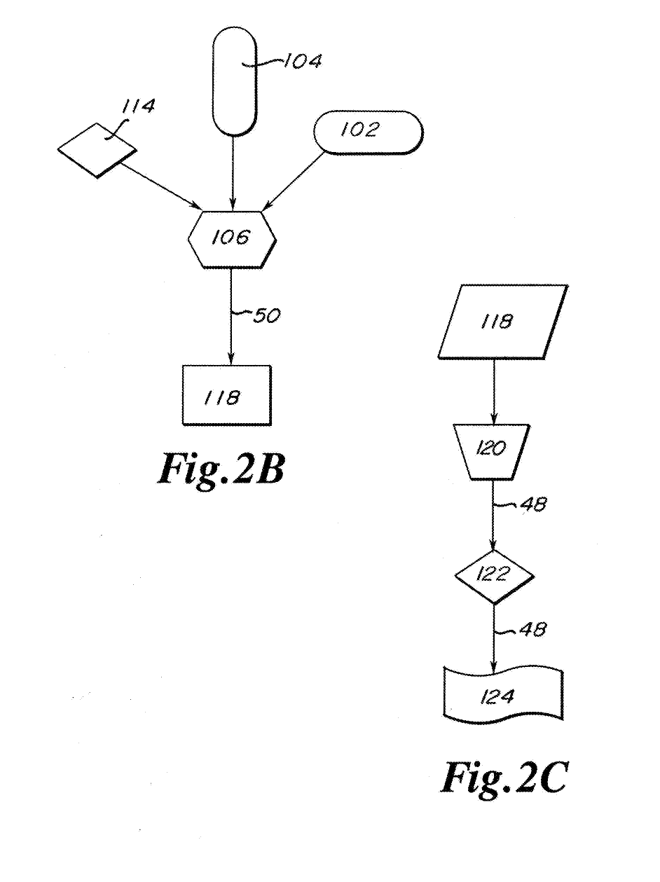

Referring to FIGS. 2A, 2B and 2C in one embodiment the Teff Injera 124 (Ethiopian Soft Bread) is formed of 6 cups of teff flour 14, 1 and ½ cup of starter 102 (1 cup of water with ½ cup of liquid teff mix and fermented for 24 hours) and twelve cups of water 40.

In one embodiment, the method of formation of the Teff Injera 124 includes the step of mixing 50 in a large container 106 the Teff flour 14 and 6 cups of water 40. The Teff flour 14 and 6 cups of water 40 are thoroughly mixed and then the remaining 6 cups of water 40 are gradually added while mixing 50 continues, forming the pre-injera mixture within the container 105.

In one embodiment, the method of formation of the Teff Injera 124 includes the step of covering the pie-injera mixture and letting the pre-injera mixture ferment 108 for approximately thirty-six hours wherein the water separates from the pre-injera mixture to form injera dough 110.

In one embodiment, the method of formation of the Teff Injera 124 includes the step of removing ½ cup 116 of the pre-injera mixture after twenty-four hours and prior to the removal of the injera dough 110, and mixing 50 the ½ cup 116 of the pre-injera mixture with 1 cup of water 40 to form the starter 102.

After the expiration of approximately thirty-six hours, in one embodiment, the method of formation of the Teff Injera 124 includes the step of removing 112 the injera dough 110 from the reserve, water 104 and placing the injera dough 110 into a refrigerator 114 for an additional 4 hour period of time. The reserve water 104 is the water which remains in the container 106 following the removal of the injera dough 110. The reserve water 104 may then be placed into a separate container. The reserve water 104 includes dissolved flour, which has not congealed into the injera dough 110.

After the expiration of approximately forty hours, in one embodiment, the method of formation of the Teff Injera 124 includes the step of gradually adding and mixing 50 the starter 102 back into the reserve water 104. The injera dough 110 is then adding to the reserve water 104 and starter 102, and is thoroughly mixed 50 forming an injera mixture 118. The injera mixture 18 when adequately mixed will have the appearance of being a little thinner than a mixed pancake batter.

In one embodiment, the method of formation of the Teff Injera 124 includes the step of heating 48 a griddle 120 to approximately 400 degrees Fahrenheit. Then 1 cup 122 of the injera mixture 118 may be poured in a circular motion over the heated griddle 120. The griddle 120 and era mixture 118 may then be covered and cooked for approximately thirty seconds. The cover may then be removed from the 120 and the cooked Teff Injera 124 may be removed from the griddle 120 and permitted to cool to a desired temperature.

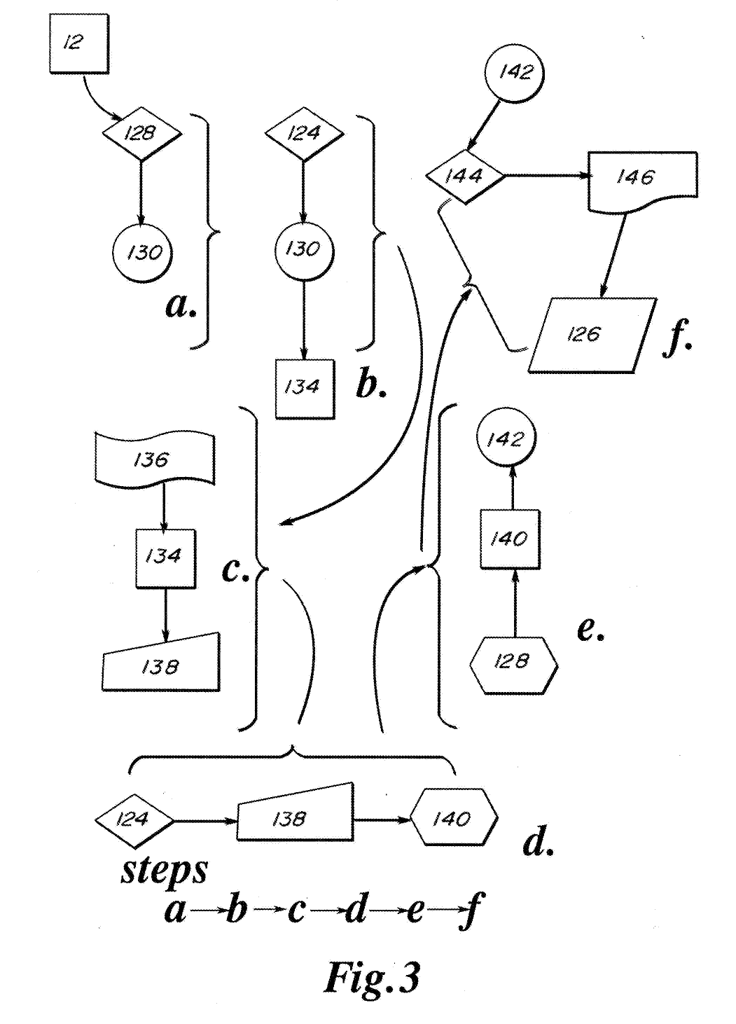

Referring to FIG. 3 in one embodiment, the method of formation of the Teff Pie 10 includes the step of preheating an oven 120 to 400 degrees Fahrenheit.

On a lightly floured surface one-half of the piecrust dough 12 may be rolled out 128 into a ⅛ inch thick circle, having at least a 10-inch diameter dimension. The rolled out ½ piecrust dough 12 is then transferred into a 10-inch deep baking pan 130. The ½ portion of piecrust dough 12 may be spread if necessary and the edges may be trimmed. Then ½ of one of the cooked Teff Injera 124 is placed into the baking pan 130 as the lower layer of Teff Injera 124 above the piecrust dough 12. The baking, pan 130 now has a lower layer of piecrust dough 12 and a lower layer of Teff Injera 124 represented by reference numeral 134.

In one embodiment, the method of formation of the Teff Pie 10 includes the step of placing 6 to 8 tablespoons of at least one, or a combination of the sauces 136 onto the ½ Teff Injera 124 in the baking pan. The baking pan 130 now has a lower layer of pie crust dough 12, a lower layer of Teff Injera 124, and a layer of sauces 136 represented by reference numeral 138.

In one embodiment, the method of formation of the Teff Pie 10 includes the step of placing the other ½ of the cooked Injera 124 on top of the sauces 136 in the baking pan 130. The baking pan 130 now has a lower layer of piecrust dough 12, a lower layer of Teff Injera 124, a layer of sauces 135, and an upper layer of Teff Injera 124 represented by reference numeral 140.

In one embodiment, the method of formation of the Teff Pie 10 includes the step of placing the other ½ of the rolled out pie crust dough 12 on top of the upper layer of Teff Injera 124. The baking pan 130 now has a lower layer of pie crust dough 12, a lower layer of Teff Injera 124, a layer of sauces 136, an upper layer of Teff Injera 124 and an upper layer of pie crust dough 12 represented by reference numeral 142. The edges of the upper layer of piecrust dough 12 nay then be trimmed. A slit 144 is then cut into the top layer of the piecrust dough 12 and the top layer of the piecrust dough 12 may be brushed with egg white. The baking pan 130 may then be placed onto a foil-lined baking sheet 146.

In one embodiment, the method of formation of the Teff Pie 10 includes the step of placing the baking pan 130 in the oven 126 for twenty-five minutes at 400 degrees Fahrenheit. After twenty-five minutes of cooking the heat, 48 may be reduced to 350 degrees Fahrenheit and baking may continue for additional fifteen minutes of time. The Teff Pie 10 may then be removed from the oven 126, placed on a wire cooling rack and allowed to cool to a desired temperature.

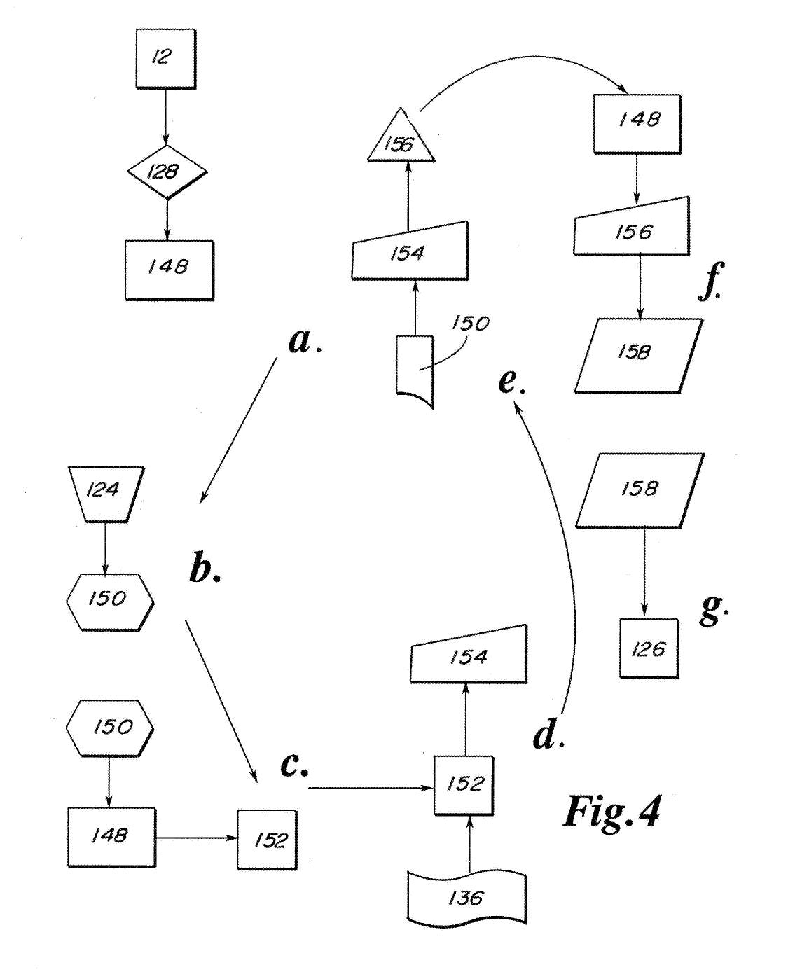

Referring to FIGS. 4 and 14, in at least one alternative embodiment, the method of formation of the Teff Pie 10 includes the steps previously identified for the formation of the piecrust dough 12 and Teff Injera 124.

In at least one alternative embodiment, the method of formation of the Teff Pie 10 includes the step of: on a lightly floured surface, one-half of the pie crust dough 12 may be rolled out 128 into a ⅛ inch thick circle, having at least a 10 inch diameter dimension. The rolled out ½ piecrust dough 12 is then cut into small flat squares 148. The cooked Teff Injera 124 is also cut into small flat squares 150 having the same dimensions as the cut piecrust dough 12. One of the cut Teff Injera squares 150 is then placed on top of a cut square of pie crust dough 148 represented by reference numeral 152. A desired amount of at least one of the sauces 136 is then placed on top of the cut square of Teff Injera 150 represented by reference numeral 154. Another cut square of cooked. Teff Injera 150 is then placed on top of the sauces 136 represented by reference numeral 156. Another cut square 148 of pie crust dough 12 is then placed on top of the upper cut piece 150 of cooked Teff Injera 124 represented by reference numeral 158. The edges of the layered Teff Pie 10 are then pinched and sealed. The squares 158 of Teff Pie 10 are then baked for approximately 20 minutes t a temperature of 400 degrees Fahrenheit, whereupon the squares 158 of cooked Teff Pie 10 are removed from heat 48 and allowed to cool to a desired temperature.

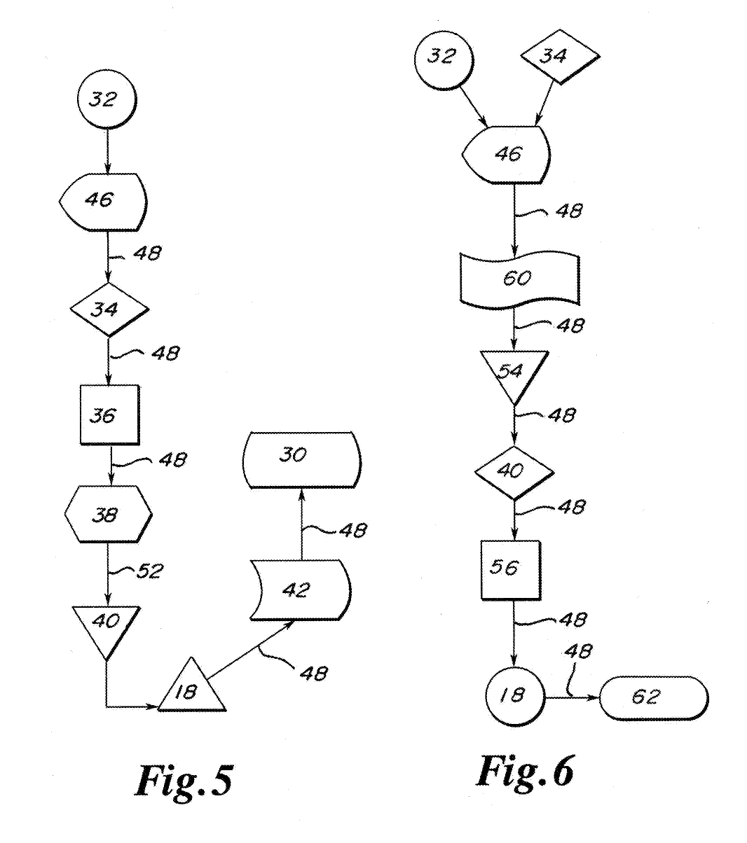

In at least one alternative embodiment, the method of formation of the Teff Pie 10 includes the step of forming a Key Sir sauce 30 as depicted in FIG. 5. In at least one embodiment the method of making of the Key Sir sauce 30 begins by the acquisition of the ingredients of ½ cup oil 32, 1 diced yellow onion 34, ½ teaspoon salt 18, 1.5 teaspoon minced garlic 36, 3 large beets diced 38, 1.5 cups water 40, 5 large potatoes diced 42, and 1 jalapeno 44.

In at least one alternative embodiment, the Key Sir sauce 30 is formed by heating 48 the oil 32 in a large pot 46 over medium heat. Adding the onion 34 and cooking the onion 34 in the oil 32 at medium heat until the onion 34 softens in approximately five to eight minutes. To the cooked onion 34, add the garlic 36 and cook for one additional minute at medium heat. Then add beets 38 and stir 52 to combine the ingredients. The water 40 and salt 18 may then be added and the pot 46 is covered bringing the ingredients to boil at medium heat. The Key Sir sauce 30 is cooked for approximately eighteen 18 minutes at medium heat 48 whereon the potatoes 42 are added. Continue to cook the Key Sir sauce 30 at medium heat until the potatoes 42 soften (about 15 minutes).

In at least one alternative embodiment, the method of formation of the Teff Pie 10 includes the step of forming a Shiro Wat sauce 62 (Chickpea Stew) as depicted in FIG. 6. In at least one embodiment the method of making of the Shiro Wat sauce 62 begins by the acquisition of the ingredients of 1 yellow onion 34 chopped, ½ cup oil 32, 2 tablespoon tomato paste 54, 3 cups of water 40, 1 cup of shiro (chickpea powder) 56, 1 tablespoon garlic 36 and ginger 70 minced, and 1 teaspoon salt 18.

In at least one alternative embodiment, the Shiro Wat sauce 62 is formed by cooking the onion 34 on medium heat 48 with the oil 32 for 5 minutes. The garlic 36 and ginger 70 are then added. The Shiro Wat sauce 62 is then cooked for an additional 3 minutes at medium heat 48. The tomato paste 54 is then added and cooked for another 3 minutes at medium heat 48. The water 40 is then added and the Shiro Wat sauce 62 is brought to boil over high heat 48. The shim 56 is then slowly added while stirring 52 to remove any lumps. Add salt 18 and continue to cook for another ½ hour at low heat 48 to form the Shiro Wat sauce 62.

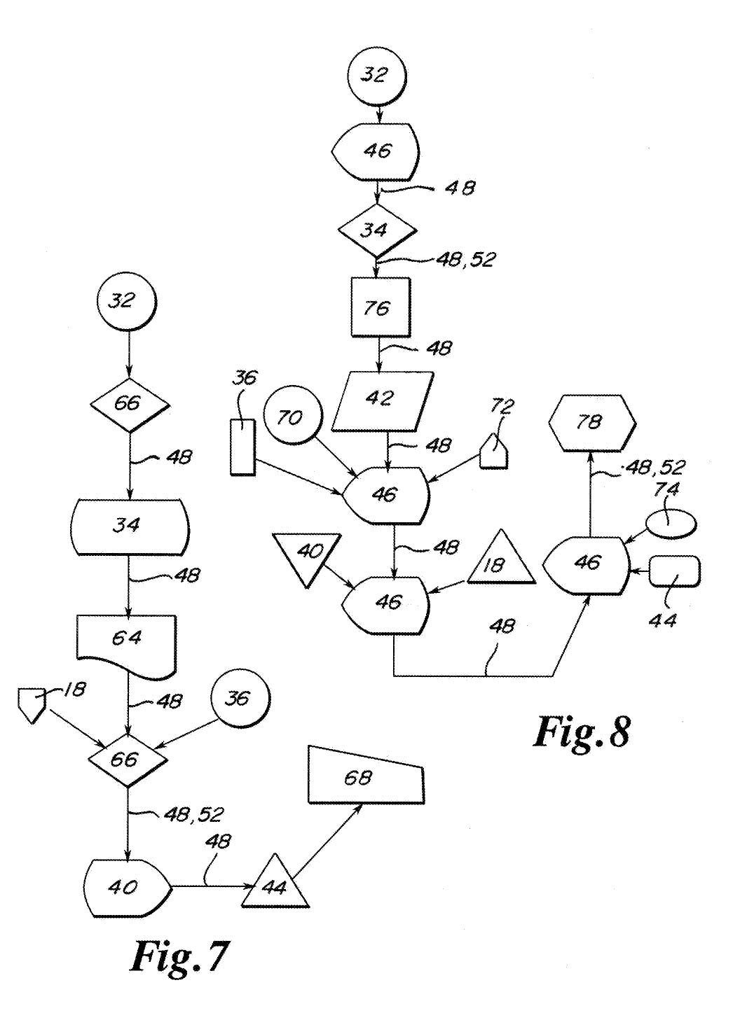

In at least one alternative embodiment, the method of formation of the Teff Pie 10 includes the step of forming a Gomen Wat (Collard Greens) sauce 68 as depicted in FIG. 7. In at least one embodiment the method of making of the Gomen Wat sauce 68 begins by the acquisition of the ingredients of 1 lb. Collard greens 64 which have been trimmed and chopped, 1 cup water 40, ½ cup vegetable oil 32, 1 yellow onion chopped 34, 5 chopped cloves of garlic 36, 1 jalapeno 44 and 1 tablespoon salt 18.

In at least one alternative embodiment, the Gomen Wat sauce 68 is formed by heating the oil 32 over medium heat 48 in a large saucepan 66. The onion 34 is then added and cooked for one minute at medium heat 48. The Collard greens 64 are then added and cooking continues for another 5 minutes at medium heat 48. The Gomen Wat sauce 68 is then stirred 52 and the salt 18 and garlic 36 are added and cooked for an additional 2 minutes at medium heat 48. The water 40 is then added and the large saucepan 66 is covered and cooked on medium heat 48 for an additional 10 minutes while stirring 52 occasionally. The jalapeño 44 is then added to form the Gomen Wat sauce 68.

In at least one alternative embodiment, the method of formation of the Teff Pie 10 includes the step of forming a Tikel Gomen (Cabbages) sauce 78 as depicted in FIG. 8. In at least one embodiment the method of making of the Tikel Gomen sauce 78 begins by the acquisition of the ingredients of 1 cup oil 32, 2 medium yellow onions thinly sliced 34, 2 large potatoes, peeled and cut in cubes 42, 1 tablespoon ginger puree 70, 1 tablespoon garlic puree 36, ½ teaspoon turmeric 72, 1 teaspoon salt 18, 1 cup water 40, 1 medium head of cabbage chopped 74, 1 jalapeno sliced 44 and 2 sticks carrot cut in small pieces 76.

In at least one alternative embodiment, the Tikel Gomen sauce 78 is formed by heating the oil 32 over medium heat 48 in a pot/saucepan 44, 66. The onion 34 is then added and cooked for 5 minutes while stirring 52 at medium heat 48. The carrots 76 are then added and cooked for another 3 minutes at medium heat 48 and then the potato 42 is added. The pot 46 or saucepan 66 is then covered and cooking continues for another 5 minutes at medium heat 48. The garlic 36, ginger 70 and turmeric 72 are then added. The water 40 and salt 18 are then added and cooked for another 3 minutes at medium heat 48. The cabbages 74 and jalapeno 44 are then added and cooked while stirring 52 for another 4 minutes at medium heat 48. The pot 46 or saucepan 66 is then covered and cooking continues while occasionally stirring 52 until the vegetables soften which occurs after about 7 additional minutes of cooking at medium heat 48 forming the Tikel Gomen sauce 78.

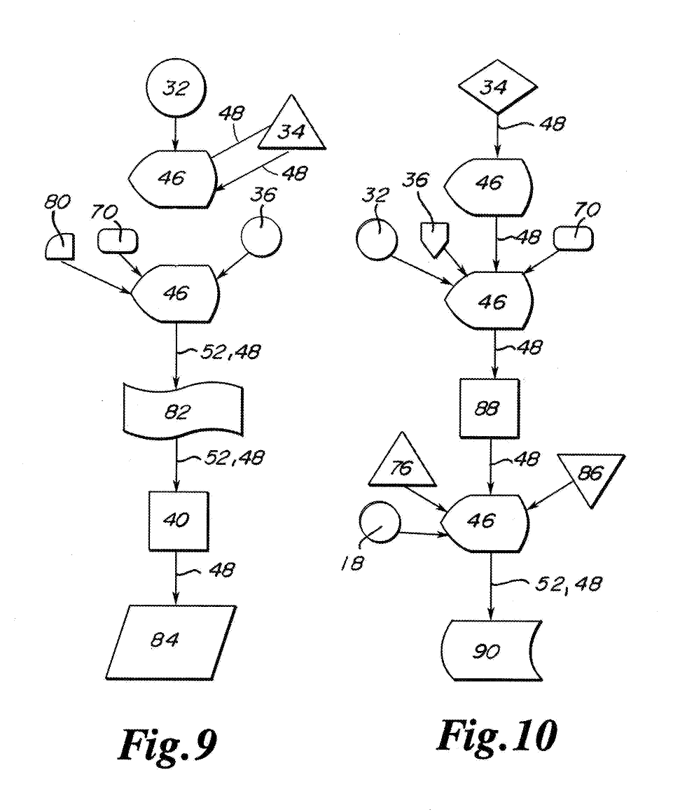

In at least one alternative embodiment, the method of formation of the Teff Pie 10 includes the step of forming a Yemesir Wat (Split Lentil Stew) sauce 84 as depicted in FIG. 9. In at least one embodiment the method of making of the Yemesir Wat sauce 84 begins by the acquisition of ½ cup vegetable oil 32, 2 medium yellow onions chopped 34, ½ cup berbere (Ethiopian mix of spies) 80, 1 tablespoon ginger puree 70, 1 tablespoon garlic puree 36, 1 cup washed split red lentil 82, 3 cups of water 40 and 1 teaspoon salt 18.

In at least one alternative embodiment, the Yemesir Wat sauce 84 is formed by heating the oil 32 over medium heat 48. The onion 34 is then added and cooked for about 8-10 minutes at medium heat 48. The berbere 80, ginger 70 and garlic 36 are then stirred 52 into the pot 46 or saucepan 66 and cooked for 2 additional initiates while stirring 52 at medium heat 48. The lentils 82 are then added and cooked for an additional 2-3 minutes while stifling 52 at medium heat 48. The water 40 is then added and the sauce is brought to boil at high heat 48. The heat 48 is then reduced to medium-low allowing the sauce to simmer while stirring 52 until the mixture thickens forming the Yemesir Wat sauce 84.

In at least one alternative embodiment, the method of formation of the Teff Pie 10 includes the step of forming a Fossolia (Green beans) sauce 90 as depicted in FIG. 10. In at least one embodiment the method of making of the Fossolia sauce 90 Begins by the acquisition of 2 onions sliced 34, 1 cup oil 32, 5 cups fossolia (ends cut and halves) 86, 4 carrot sticks cut in small pieces 76, 2 tomatoes diced 88, ½ tablespoon ginger minced 70, ½ tablespoon garlic minced 36 and 1 teaspoon salt.

In at least one alternative embodiment, the Fossolia sauce 90 is formed by cooking the onion 34 over medium heat 48 for about 5-7 minutes. The oil 32, garlic 36 and ginger 70 are then added and cooked for an additional 5 minutes at medium heat 48. The tomato 88 is then added and cooked for and additional ten minutes at medium heat 48. The carrots 76, fossolia 86 and salt 18 are then added and the sauce is well-stirred 52 and cooked for an additional 15 minutes at medium heat 48 until the vegetables are tender forming the Fossolia sauce 90.

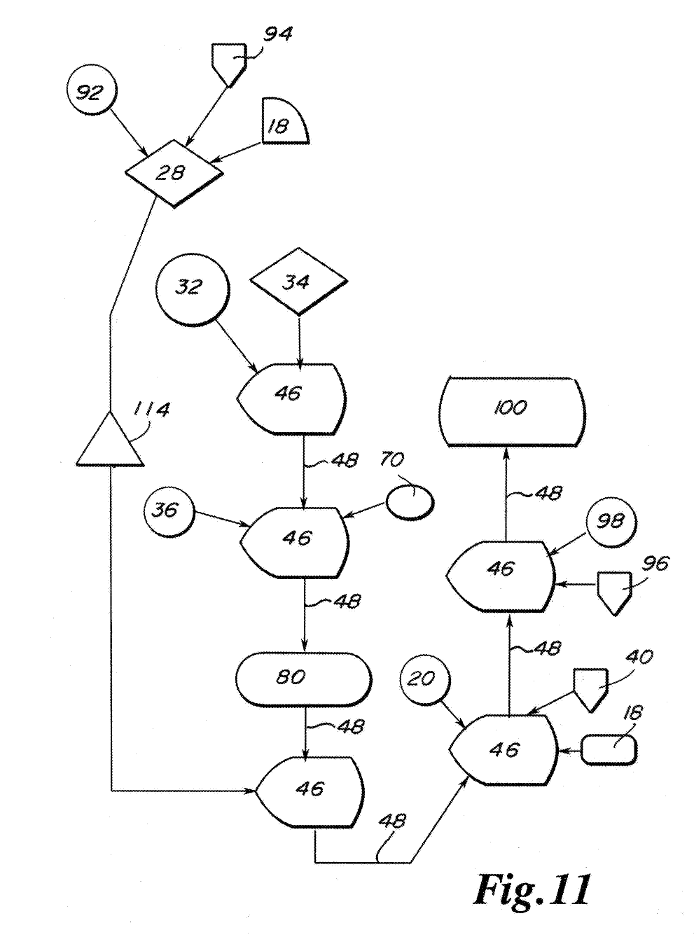

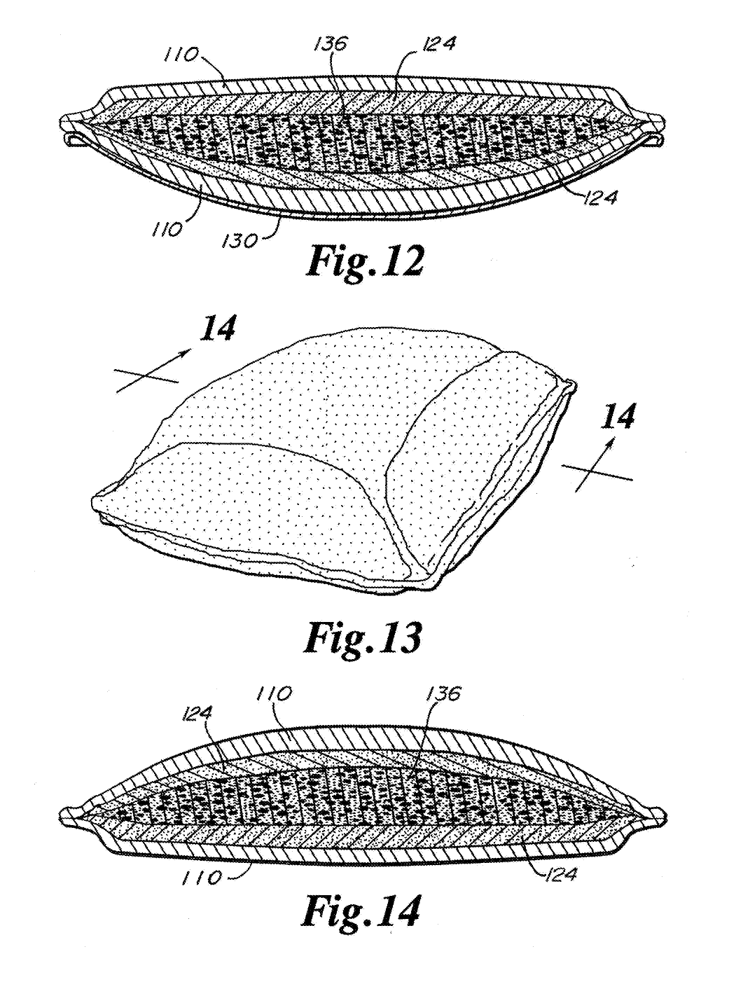

In at least one alternative embodiment, the method of formation of the Teff Pie 10 includes the step of forming a Doro Wat (Chicken stew) sauce 100 as depicted in FIG. 11. In at least one embodiment the method of making of the Doro Wat sauce 100 begins by the acquisition of 2 lbs. of skinless chicken legs or breasts 92, lemon juice 94, 4 large red onions finely chopped 34, 1.5 cups berbere 80, 1.5 cups butter (Kibe) 20, 1.4 cup fresh garlic (minced), 36, ¼ cup ginger (minced) 70, 1.5 cup water 40, 6 pealed hard boiled eggs 95, ½ cup oil 32, 1 teaspoon salt 18 and 1 tablespoon mekeleshia (Ethiopian mixed spices) 98.

In at least one alternative embodiment, the Doro Wat sauce 100 is formed by washing the chicken 92 in cold water and soaking the chicken 92 with lemon juice 94 and salt 18 and placing the soaking chicken 92 in a refrigerator 114 for 1 hour. The onion 34 and the oil 32 are then cooked over medium heat 48 for about ½ hour. The garlic 36 and ginger 70 are then added and cooked for an additional ½ hour over medium heat 48. The berbere 80 is then added and cooked for an additional 45 minutes at medium heat 48. The marinated chicken 92 is then added and cooked for another 15 minutes at medium heat 48. The butter (kibe) 20, salt 18 and water 40 are then added and cooking continues for another ½ h our at medium heat 48. The mekeleshia (Ethiopian mixed spies) 98 and the eggs 96 are then added and cooked at low heat 48 for additional 15 minutes forming it Doro Wat sauce 100.

This completes the description of the preferred and alternate embodiments of the invention. Those skilled in the art may recognize other equivalents to the specific embodiment described herein which equivalents are intended to be encompassed by the claims attached hereto.

The above disclosure is intended to be illustrative and not exhaustive. This description will suggest many variations and alternatives to one of ordinary skill in this art. The various elements shown in the individual figures and described above may be combined or modified as desired. All these alternatives and variations are intended to be included within the scope of the claims where the term “comprising” means “including, but not limited to”.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

I claim:

1. A method for making a Teff Pie, the method comprising;
acquiring one cup teff flower, one and one-half cups all-purpose flower, one teaspoon salt, one stick unsalted butter (chilled), one-quarter teaspoon fenugreek powder, one teaspoon black seed, and ten tablespoons ice water;
mixing said fenugreek, said black seed, said salt, said teff flower and said all-purpose flour in a container;
cutting and adding said butter into said container and mixing until such time as said fenugreek, said black seed, said salt, said teff flower, said all-purpose flour and said butter has a course appearance;
gradually adding and mixing said ice water with said mixed fenugreek, said black seed, said salt, said teff flower, said all-purpose flour and said butter forming a piecrust dough;
acquiring six additional cups of Teff flour and six additional cups of water and placing said additional cups of water and said additional Teff flour into a container and mixing said additional cups of water and said additional Teff flour;
gradually adding and mixing another six cups of water with said mixed additional cups of water and said additional Teff flour forming a pre-injera mixture;
covering said pre-injera fixture and letting said pre-injera mixture ferment for approximately thirty-six hours, wherein said water separates from said pre-injera mixture to form injera dough;
removing after approximately thirty-six hours said injera dough from said fermented pre-injera mixture and placing said injera dough into a refrigerator for approximately four hours;
collecting said water from said pre-injera mixture following removal of said injera dough, said remaining water being identified as reserve water;
placing said reserve water in a separate container, said reserve water comprising dissolved flour which did not congeal into said injera dough;
removing after twenty-four hours following the initiation, of said fermentation one-half cup of said mixed additional teff flour and said additional water prior to the removal of said injera dough from said pre-injera mixture;
mixing said one-half cup of said mixed additional teff flour and said additional water with one cup of further water to form a starter;
gradually adding and mixing after approximately forty hours following initiation of said fermentation said starter and said reserve water;
adding and thoroughly mixing said cooled injera dough to said mixed starter and said reserve water forming an injera mixture;
heating a griddle to approximately 400 degrees Fahrenheit;
pouring one cup of said injera mixture in a circular motion over said heated griddle;
covering said heated griddle and cooking said injera mixture for approximately thirty seconds forming injera;
removing, said cover and said injera from said griddle allowing said injera to cool;
preheating an oven to 400 degrees Fahrenheit;
rolling out on a lightly floured surface one-half of said pie crust dough into a one-eighth inch thick circle, said circle having a diameter dimension of approximately ten inches said one-half of said piecrust dough being a lower layer of piecrust dough;
rolling out on a lightly floured surface a remaining one-half of said pie crust dough into a one-eighth inch thick circle, said circle having a diameter dimension of approximately ten inches said remaining one-half of said piecrust dough being an upper layer of piecrust dough;
transferring said lower layer of piecrust dough into a baking pan;
placing on lop of said lower layer of piecrust dough in said baking pan one-half of said injera as a lower layer of injera;
adding approximately six to eight tablespoons of at least one sauce on top of said lower layer of injera in said baking pan;
placing a remaining one-half of said injera on top of said sauces in said baking pan as an upper layer of injera;
covering said baking pan with said upper layer of piecrust dough;
placing said baking pan in the oven for twenty-five minutes at 400 degrees Fahrenheit;
reducing the temperature in said oven to 350 degrees Fahrenheit and baking for an additional fifteen minutes; and
removing said Teff Pie from said oven and allowing said Teff Pie to cool.

2. The method of claim 1, wherein said sauces are selected from the group consist Key Sir sauce, Shiro Wat sauce, Gomen Wat sauce, Tikel Gomen sauce, Yemesir Wat Sauce, Fossolia sauce, and Doro Wat sauce, and combinations thereof.

3. The method according to claim 1, wherein the sauce is Key Sir sauce, said Key Sir sauce being formed by a method comprising;
acquiring one-half cup of oil, one diced yellow onion, one-half teaspoon salt, one and one-half teaspoons minced garlic, three large beets diced, one and one-half cups water, five large potatoes diced, and one jalapeno;
heating said oil in a pot over medium heat and adding said onion and cooking said onion in said oil at medium heat until said onion softens in approximately five to eight minutes;
adding to said pot said garlic and cooking for one additional minute at medium heat;
adding to said pot said beets and stirring;
adding to said pot said water and said salt and covering said pot and bringing said onion, said garlic, said beets, said water, and said salt to boil at medium heat and cooking for approximately eighteen 18 minutes; and
adding said potatoes and cooking at medium heat for approximately fifteen minutes until said potatoes soften.

4. The method according to claim 1, wherein the sauce is Shiro Wat sauce said Shiro Wat sauce being formed by a method comprising;
acquiring one yellow onion chopped, one-half cup oil, two tablespoons tomato paste, three cups of water, one cup of shiro (chickpea powder), one tablespoon of garlic and ginger minced, and one teaspoon salt;
cooking said onion on medium heat with said oil for five minutes adding said garlic and said ginger and cooking for an additional three minutes at medium heat;
adding said tomato paste and cooking for another three minutes at medium heat;
adding said water and bringing to boil over high heat;
stirring while slowly adding said shiro to remove any lumps, and
adding said salt and cooking for another thirty minutes at low heat.

5. The method according to claim 1, wherein the sauce is Gomen Wat sauce said Gomen Wat sauce being formed by a method comprising;
acquiring one pound of Collard greens which have been trimmed and chopped, one cup water, one-half cup vegetable oil, one yellow onion chopped, five chopped doves of garlic, one jalapeno, and one tablespoon salt;
heating said oil over medium heat in a large saucepan;
adding said onion and cooking for one minute at medium heat;
adding said Collard greens and cooking for another five minutes at medium heat;
stirring and adding said salt and said garlic and cooking for an additional two minutes at medium heat;
adding said water and covering said saucepan and cooking on medium heat for an additional ten minutes while stirring occasionally; and
adding said jalapeño.

6. The method according to claim 1, wherein the sauce is Tikel Gomen sauce said Tikel Gomen sauce being formed by a method comprising;
acquiring one cup oil, two medium yellow onions thinly sliced two large potatoes peeled and cut in cubes, one tablespoon ginger puree, one tablespoon garlic puree, one-half teaspoon turmeric, one teaspoon salt, one cup water, one medium head of cabbage chopped, one jalapeno sliced, and two sticks carrot cut in small pieces;
heating said oil over medium heat in a pot/saucepan;
adding said onion and cooking for five minutes while stirring at medium heat;
adding said carrots and cooking for another three minutes at medium heat;
adding said potato and covering said pot/saucepan and cooking for another five minutes at medium heat;
adding said garlic, said ginger, and said turmeric;
adding said water and said salt and cooking for another three minutes at medium heat;
adding said cabbages and said jalapeno and cooking while stirring for another four minutes at medium heat; and
covering said pot/saucepan and cooking at medium heat while occasionally stirring for approximately seven minutes until said onions, said potatoes, said cabbage and said carrots soften.

7. The method according to claim 1, wherein the sauce is Yemesir Wat sauce said Yemesir Wat sauce being formed by a method comprising;
acquiring one-half cup vegetable oil, two medium yellow onions chopped, one half cup berbere (Ethiopian mix of spies); one tablespoon ginger puree, one tablespoon garlic puree, one cup washed split red lentils, three cups of water, and one teaspoon salt;
heating said oil over medium heat and adding said onion and cooking for approximately eight to ten minutes at medium heat;
adding said berbere said ginger, and said garlic, and then stirring for two additional minutes at medium heat;
adding said lentils and cooking for an additional two to three minutes while stirring at medium heat;
adding said water and bringing to boil on high heat;
reducing said heat to medium-low allowing simmering while stirring until thickening occurs.

8. The method according to claim 1, wherein the sauce is Fossolia sauce said Fossolia sauce being formed by a method comprising;
acquiring two onions sliced, one cup oil, five cups fossolia (ends cut and halves), four carrot sticks cut in small pieces, two tomatoes diced, one-half tablespoon ginger minced, one-half tablespoon garlic minced and one teaspoon salt,
cooking said onion over medium heat for about five to seven minutes;
adding said oil, said garlic and said ginger and cooking for an additional five minutes at medium heat;
adding said tomato and cooking for an additional ten minutes at medium heat; and
adding said carrots, said fossolia and said salt stirring and cooking for an additional fifteen minutes at medium heat until said onion, said fossolia, said can of sticks, and said tomatoes become tender.

9. The method according to claim 1, wherein the sauce is Doro Wat sauce said Doro Wat sauce being formed by a method comprising;
acquiring two pounds of skinless chicken legs or breasts, lemon juice, four large red onions finely chopped, one and one-half cups berbere, one and one-half cups butter (Kibe), one and one-quarter cups fresh garlic (minced), one-quarter cup ginger (minced), one and one-half cups water, six pealed hard boiled eggs, one-half cup oil, one teaspoon salt, and one tablespoon mekeleshia (Ethiopian mixed spices);
washing said chicken in cold water and soaking said chicken in said lemon juice and said salt and placing said soaking chicken in a refrigerator for approximately one hour cooking said onion and said oil over medium heat for approximately one-half hour;
adding said garlic and said ginger and cooking for an additional one-half hour over medium heat
adding said berbere and cooking for an additional forty-five minutes at medium heat;
adding said soaking chicken and cooking for an additional fifteen 15 minutes at medium heat;
adding said butter (kibe), said salt, and said water and cooking for another one-half hour at medium heat;
adding said mekeleshia (Ethiopian mixed spies and said eggs and cooking at low heat for an additional fifteen 15 minutes.

10. A method for making a Teff Pie, the method comprising:
acquiring one cup teff flower, one and one-half cups all-purpose flower, one teaspoon salt, one stick unsalted butter (chilled), one-quarter teaspoon fenugreek powder, one teaspoon black seed, and ten tablespoons ice water;
mixing said fenugreek, said black seed, said salt, said teff flower and said all-purpose flour in a container;
cutting and adding said butter into said container and mixing until such time as said fenugreek, said black seed, said salt, said teff flower, said all-purpose flour and said butter has a course appearance;
gradually adding and mixing said ice water with said mixed fenugreek, said black seed, said salt, said teff flower, said all-purpose flour and said butter forming a piecrust dough;
acquiring six additional cups of Teff flour and six additional cups of water and placing said additional cups of water and said additional Teff flour into a container and mixing said additional cups of water and said additional Teff flour;
gradually adding and mixing another six cups of water with said mixed additional caps of water and said additional Teff flour forming a pre-injera mixture;
covering said pre-injera mixture and letting said pre-injera mixture ferment for approximately thirty-six hours, wherein said water separates from said pre-injera mixture to form injera dough;
removing after approximately thirty-six hours said injera dough from said fermented pre-injera mixture and placing said injera dough into a refrigerator for approximately four hours;
collecting said water from said pre-injera mixture following removal of said injera dough, said remaining water being identified as reserve water;
placing said reserve water in a separate container, said reserve water comprising dissolved flour which did not congeal into said injera dough;
removing after twenty our hours following the initiation of said fermentation one-half cup of said mixed additional teff flour and said additional water prior to the removal of said injera dough from said pre-injera mixture;
mixing said one-half cup of said mixed additional teff flour and said additional water with one cup of further water to form a starter;
gradually adding and mixing after approximately forty hours following initiation of said fermentation said starter and said reserve water;
adding and thoroughly mixing said cooled injera dough to said mixed starter and said reserve water forming an injera mixture;
heating a griddle to approximately 400 degrees Fahrenheit;
pouring one cup of said injera mixture in a circular motion over said heated griddle;
covering said heated griddle and cooking said injera mixture for approximately thirty seconds forming an injera;
removing said cover and said injera from said griddle allowing said injera to cool;
preheating an oven to 400 degrees Fahrenheit;
rolling out on a lightly floured surface one-half of said pie crust dough into a one-eighth inch thick circle, said circle having a diameter dimension of approximately ten inches said one-half of said piecrust dough being a lower layer of piecrust dough;
rolling out on a lightly floured surface a remaining one-half of said pie crust dough into a one-eighth inch thick circle, said circle having a diameter dimension of approximately ten inches said remaining one-half of said piecrust dough being an upper layer of piecrust dough;
cutting the lower layer of piecrust dough and the upper layer of piecrust dough in small flat squares, said small flat squares having the same dimensions;
cutting the injera into small flat injera squares, said small flat injera squares having the same dimension as said small flat squares of piecrust dough;
placing one of said small flat squares of piecrust dough on a surface as said lower layer of piecrust dough;
placing one small flat injera square as a lower layer of injera on top of said lower layer of piecrust dough;
placing a desired amount of at least, one of sauce or combination of sauces on top of said lower layer of injera;
placing another of said small flat injera squares on top of said sauces as said upper layer of injera;
placing another small flat square of piecrust dough on top of the upper layer of injera said upper layer of piecrust dough;
pinching and sealing edges of said lower layer of piecrust dough, said lower layer of injera, said upper layer of injera and said upper layer of piecrust dough;
baking said lower layer of piecrust dough, said lower layer of injera, said sauce, said upper layer of era and said upper layer of piecrust dough for approximately twenty minutes at 400 degrees Fahrenheit making said Teff Pie; and
removing said Teff Pie from said heat and allowing said Teff Pie to cool.

11. The method of claim 10, wherein said sauces are selected from the group consisting of Key Sir sauce, Shiro Wat sauce, Gomen Wat sauce, Tikel Gomen sauce, Yemesir Wat sauce, Fossolia sauce, and Doro Wat sauce, and combinations thereof.

12. The method according to claim 10, wherein the sauce is Key Sir sauce, said Key Sir sauce being formed by a method comprising;
acquiring one-half cup of oil, one diced yellow onion, one-half teaspoon salt, one and one-half teaspoons minced garlic, three large beets diced, one and one-half cups water, five large potatoes diced, and one jalapeno;
heating said oil in a pot over medium heat and adding said onion and cooking said onion in said oil at medium heat until said onion softens in approximately five to eight minutes;
adding to said pot said garlic and cooking for one additional minute at medium heat;
adding to said pot said beets and stirring;
adding to said pot said water and said salt and covering said pot and bringing said onion, said garlic, said beets, said water, and said salt to boil at medium heat and cooking for approximately eighteen 18 minutes; and
adding said potatoes and cooking at medium heat for approximately fifteen minutes until said potatoes soften.

13. The method according to claim 10, wherein the sauce is Shiro Wat sauce said Shiro Wat sauce being formed by a method comprising;
acquiring one yellow onion chopped, one-half cup oil, two tablespoons tomato paste, three cups of water, one cup of shiro (chickpea powder), one tablespoon of garlic and ginger minced, and one teaspoon salt;
cooking said onion on medium heat with said oil for five minutes
adding said and said ginger and cooking for an additional three minutes at medium heat;
adding said tomato paste and cooking for another three minutes at medium heat;
adding said water and bringing to boil over high heat:
stirring slowly adding said shiro to remove any lumps; and
adding sad salt and cooking for another thirty minutes at low heat.

14. The method according to claim 10, wherein the sauce is Gomen Wat sauce said Gomen Wat sauce being formed by a method comprising;
acquiring one pound of Collard greens which have been trimmed and chopped, one cup water, one-half cup vegetable oil, one yellow onion chopped, five chopped doves of garlic, one jalapeno, and one tablespoon salt;
heating said oil over medium heat in a large saucepan;
adding said onion and cooking for one minute at medium heat;
adding said Collard greens and cooking for another five minutes at medium heat;
stirring and adding said salt and said garlic and cooking for an additional two minutes at medium heat;
adding said water and covering said saucepan and cooking on medium heat for an additional ten minutes while stirring occasionally; and
adding said, jalapeño.

15. The method according to claim 10, wherein the sauce is Tikel Gomen sauce said Tikel Gomen sauce being formed by a method comprising;
acquiring one cup oil, two medium yellow onions thinly sliced, two large potatoes peeled and cut in cubes, one tablespoon ginger puree, one tablespoon garlic puree, one-half teaspoon turmeric, one teaspoon salt, one cup water, one medium head of cabbage chopped, one jalapeno sliced, and two sticks carrot cut in small pieces;
heating said oil over medium heat in a pot/saucepan;
adding said onion and cooking for five minutes while stirring at medium heat;
adding said carrots and cooking for another three minutes at medium heat;
adding said potato and covering said pot/saucepan and cooking for another five minutes at medium heat;
adding said garlic,said ginger and said turmeric;
adding said water and said salt and cooking for another three minutes at medium heat;
adding said cabbages and said jalapeno and cooking while stirring for another four minutes at medium heat; and
covering said pot/saucepan and cooking at medium heat while occasionally stirring for approximately seven minutes until said onions, said potatoes, said cabbage and said carrots soften.

16. The method according to claim 10, wherein the sauce is Yemesir Wat sauce said Yemesir Wat sauce being formed by a method comprising;
acquiring one-half cup vegetable oil, two medium yellow onions chopped, one-half cup berbere (Ethiopian mix of spies), one tablespoon ginger puree, one tablespoon garlic puree, one cup washed split red lentils, three cups of water, and one teaspoon salt;
heating said oil over medium heat and adding said onion and cooking for approximately eight to ten minutes at medium heat;
adding said berbere said ginger, and said garlic, and then stirring for two additional minutes at medium heat;
adding said lentils and cooking for an additional two to three minutes while stirring at medium heat;
adding said water and bringing to boil on high heat;
reducing said heat to medium-low allowing simmering while stirring until thickening occurs.

17. The method according to claim 10, wherein the sauce is Fossolia sauce said Fossolia sauce being formed by a method comprising;
acquiring two onions sliced, one cup oil, five cups fossolia (ends cut and halves), four carrot, sticks cut in small pieces, two tomatoes diced, one-half tablespoon ginger minced, one-half tablespoon garlic minced and one teaspoon salt,
cooking said onion over medium heat for about five to seven minutes;
adding said oil, said garlic and said ginger and cooking for an additional five minutes at medium heat;
adding said tomato and cooking for an additional ten minutes at medium heat; and
adding said carrots, said fossolia and said salt stirring and cooking for an additional fifteen minutes at medium heat until said onions, said fossolia, said carrot sticks, and said tomatoes become tender.

18. The method according to claim 10, wherein the sauce is Doro Wat sauce said Doro Wat sauce being formed by a method comprising;
acquiring two pounds of skinless chicken legs or breasts, lemon juice, four large red onions finely chopped, one and one-half cups berbere, one and one-half cups butter (Kibe), one and one-quarter cups fresh garlic (minced), one-quarter up ginger (minced), one and one-half cups water, six pealed hard boiled eggs, one-half cup oil, one teaspoon salt, and one tablespoon mekeleshia (Ethiopian mixed spices);
washing said chicken in cold water and soaking said chicken in said lemon juice and said salt and placing said soaking chicken in a refrigerator for approximately one hour cooking said onion and said oil over medium heat or approximately one-half hour;
adding said garlic and said ginger and cooking for an additional one-half hour over medium heat
adding sad berbere and cooking for an additional forty-five minutes at medium heat;
adding said soaking chicken and cooking fir an additional fifteen 15 minutes at medium heat;
adding said butter (kibe), said salt, and said water and cooking for another one-half hour at medium heat;
adding said mekeleshia (Ethiopian mixed spies) and said eggs and cooking at low heat for an additional fifteen 15 minutes.
